(19) United States
(12) Patent Application Publication
(10) Pub. No.: US 2019/0188871 A1
(43) Pub. Date: Jun. 20, 2019

(54) ALIGNMENT OF CAPTURED IMAGES BY FUSING COLOUR AND GEOMETRICAL INFORMATION

(71) Applicant: CANON KABUSHIKI KAISHA, Tokyo (JP)

(72) Inventors: PETER ALLEINE FLETCHER, Rozelle (AU); MATTHEW RAPHAEL ARNISON, Umina Beach (AU); TIMOTHY STEPHEN MASON, Macquarie Park (AU)

(21) Appl. No.: 16/212,507

(22) Filed: Dec. 6, 2018

(30) Foreign Application Priority Data
Dec. 20, 2017 (AU) 2017279672

(51) Int. Cl. G06T 7/33; H04N 13/254; H04N 13/156; H04N 13/15; G06T 7/70; H04N 5/235; H04N 13/133

(52) U.S. Cl. CPC G06T 7/33; H04N 13/254; H04N 13/156; H04N 13/271; G06T 7/70; H04N 5/2352; H04N 13/133; H04N 13/15

(57) ABSTRACT

A method of combining object data captured from an object, the method comprising: receiving first object data and second object data, the first and second object data comprising intensity image data and three-dimensional geometry data of the object; synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data; aligning the first fused image and the second fused image; and combining the first object data and the second object data.

### REFERENCE TO RELATED PATENT APPLICATIONS

This application claims the benefit under 35 U.S.C. § 119 of the filing date of Australian Patent Application No. 2017279672, filed 20 Dec. 2017, which is hereby incorporated by reference in its entirety as if fully set forth herein.

### TECHNICAL FIELD

The invention relates generally to image processing and specifically to image alignment and registration, which is the process of bringing images into alignment with one another, such that corresponding image content occurs at the same positions within the resulting aligned images.

### BACKGROUND

When working with images, there are many situations whereby unaligned images may be encountered. Generally, images are unaligned if corresponding image content in a pair of images does not appear at corresponding coordinates of the images. Image content may include the visible texture, colours, gradients and other distinguishable characteristics of the images. For example, if the apex of a pyramid appears at a pixel coordinate (25, 300) in one image and at a pixel coordinate (40, 280) in another image, those images are unaligned. Unaligned images can arise in a number of circumstances, including (i) when multiple photographs of an object or scene are taken from different viewpoints, (ii) as a result of common image operations such as cropping, rotating, scaling or translating, (iii) as a result of differing optical properties such as lens distortion when the images were captured, and so on.

Intensity Image Alignment Methods

Image alignment techniques are used to determine a consistent coordinate space for the images (that is, a coordinate space in which, substantially, corresponding image content is located at corresponding coordinates), and to transform or map the images onto this consistent coordinate space, thereby producing aligned images. When the unaligned images are intensity images (that is, images with pixel values that represent light intensities, such as grayscale or colour images), a variety of alignment techniques may be employed.

For example, correlation-based methods align images by locating a maximum of a measure of correlation between the images, such as the cross-correlation described by the following relationship [1]:

CrossCorr(A,B)[c,d]=Σₓ₌₀^{w-1}Σ_{y=0}^{h-1}A[x,y]B[x+c,y+d],−w≤c≤w;−h≤d≤h, [1]

where A and B are images of width w pixels and height h pixels, CrossCorr(A, B) is the cross-correlation between the images A and B, x and y are coordinates along the horizontal and vertical axes respectively of the images, and c and d are horizontal and vertical offsets applied to only one of the images B. In calculating the cross-correlation, the image B is translated by the offset (c,d) and a correlation is determined between image A and this translated image. When these images are well aligned, the correlation is typically high. The cross-correlation associates (c,d) offsets with respective correlation scores. A (c,d) offset resulting in a maximum correlation score is determined from the cross-correlation, and a translation of this offset maps B onto a new coordinate space. In many cases, the new coordinate space is more consistent with the coordinate space of the image A, and therefore the images are aligned. Correlation-based methods can fail to accurately align images that have weak image texture.

Other Methods for Intensity Images, e.g. Feature Matching, RANSAC

Alternatively, feature point matching methods align images by identifying sparse feature points in the intensity images and matching corresponding feature points. Feature points are detected and characterised using techniques such as the Scale Invariant Feature Transform (SIFT). Accordingly, each detected feature point is characterised using its local neighbourhood in the intensity image to produce a feature vector describing that neighbourhood. Correspondences between feature points in each image are found by comparing the associated feature vectors. Similar feature vectors imply potential correspondences, but typically some of the potential correspondences are due to false matches. Techniques such as random sample consensus (RANSAC) are used to identify a rigid transform from the coordinate space of one image onto the coordinate space of the other image that is consistent with as many of the potential correspondences as possible. A rigid transform is a mapping of coordinates as may arise from rigid motion of a rigid object, such as rotation, scaling and translation. Rigid transforms are typically represented by a small number of parameters such as rotation, scale and translation. For example, affine transforms are rigid transforms. However a rigid transform can fail to accurately align images that are more accurately related by a non-rigid mapping (that is, a mapping of coordinates which may arise from motion of non-rigid objects or multiple rigid objects, such motion may include stretching deformations).

RGB-D Image Alignment Methods

When each image is accompanied by depth information (for example in an RGB-D image), the depth information can be used as part of a sparse feature point matching method. The depth information is used in combination with RANSAC to identify a rigid transform that is consistent with as many of the 3D correspondences as possible. Further, the depth information can be used to generate a point cloud from each image, and methods that align point clouds such as Iterative Closest Point (ICP) can be used to refine the rigid transformation produced using RANSAC. ICP uses iterated 3D geometry calculations and may be too slow for some applications unless surface simplification techniques are used.

### SUMMARY

It is an object of the present invention to substantially overcome, or at least ameliorate, one or more disadvantages of existing arrangements.

Disclosed are arrangements, referred to as Directional Illumination Feature Enhancement (DIFE) arrangements, which seek to address the above problems by enhancing three-dimensional features present in an RGB-D image of an object using directional illumination, thereby providing more robust data for image registration.

According to a first aspect of the present invention, there is provided a method of combining object data captured from an object, the method comprising:
receiving first object data and second object data, the first object data comprises first intensity image data and first three-dimensional geometry data of the object and the second object data comprises second intensity image data and second three-dimensional geometry data of the object;
synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data;
aligning the first fused image and the second fused image; and combining the first object data and the second object data.

According to another aspect of the present invention, there is provided an apparatus for combining object data captured from an object, the apparatus comprising:
a processor; and
a storage device for storing a processor executable software program for directing the processor to perform a method comprising the steps of:
receiving first object data and second object data, the first object data comprises first intensity image data and first three-dimensional geometry data of the object and the second object data comprises second intensity image data and second three-dimensional geometry data of the object;
synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data;
aligning the first fused image and the second fused image; and
combining the first object data and the second object data.

According to another aspect of the present invention there is provided a computer program product including a computer readable medium having recorded thereon a computer program for implementing any one of the methods described above.

Other aspects are also disclosed.

### BRIEF DESCRIPTION OF THE DRAWINGS

One or more embodiments of the invention will now be described with reference to the following drawings, in which:

FIG. 1A is an illustration of a photographic system for object imaging, where system cameras are geometrically related by a translation in one axis;

FIG. 1B is an illustration of a photographic system for object imaging, whereby system cameras are geometrically related by translations in and rotations about multiple axes;

FIG. 2 is a schematic flow diagram illustrating an example of a method of aligning and combining RGB-D images;

FIG. 3 is a schematic flow diagram illustrating an example of a method of fusing intensity data and three-dimensional geometry data using auxiliary directional lighting;

FIG. 4 is an illustration of an auxiliary directional lighting arrangement involving coloured directional lights as may be used in the method of FIG. 3; and

FIGS. 5A and 5B form a schematic block diagram of a general purpose computer system upon which arrangements described can be practiced;

### DETAILED DESCRIPTION INCLUDING BEST MODE

### Context

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

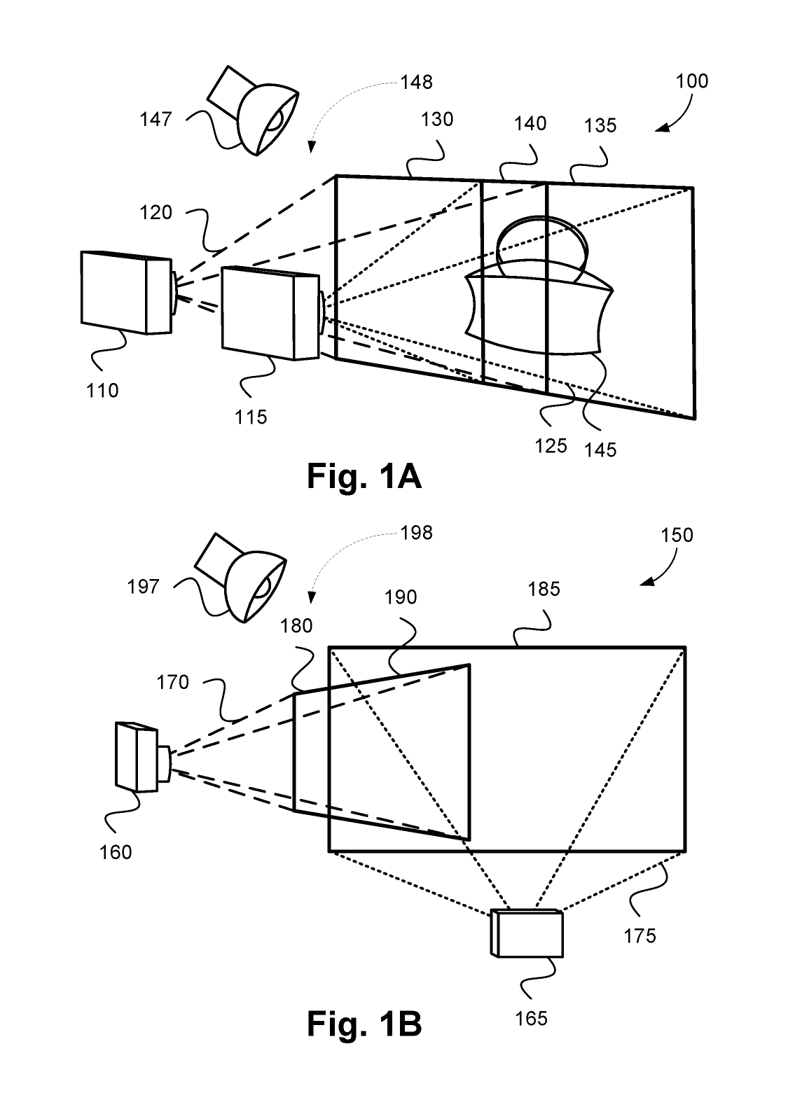

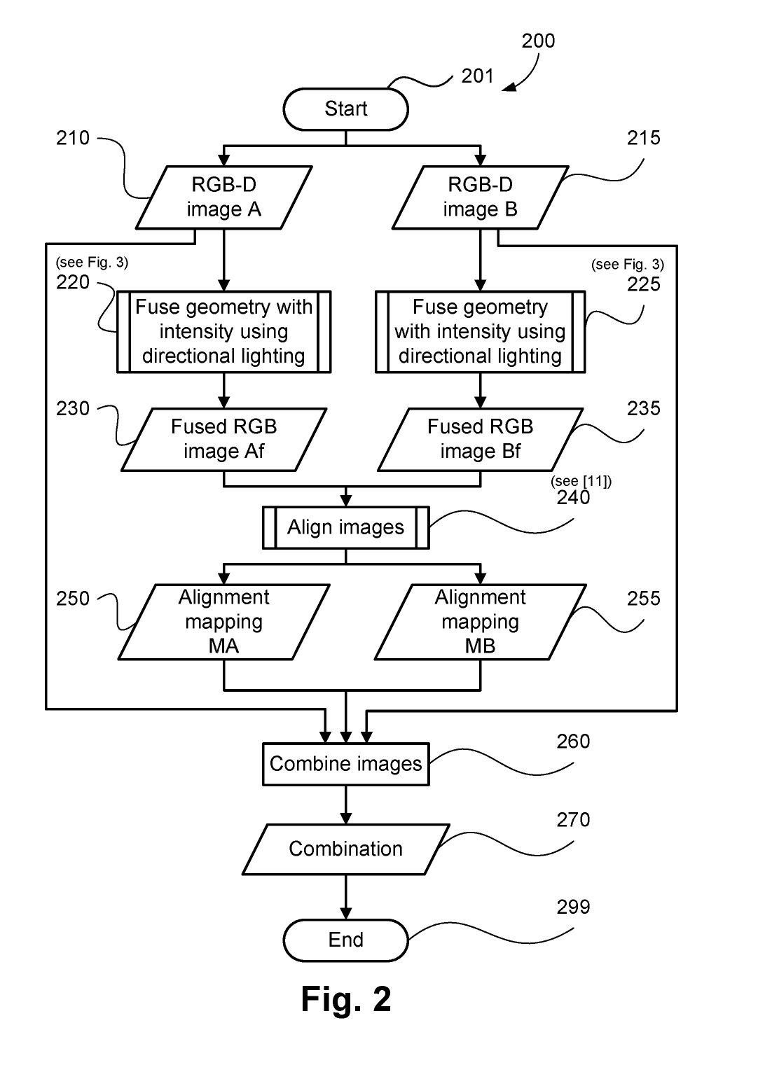

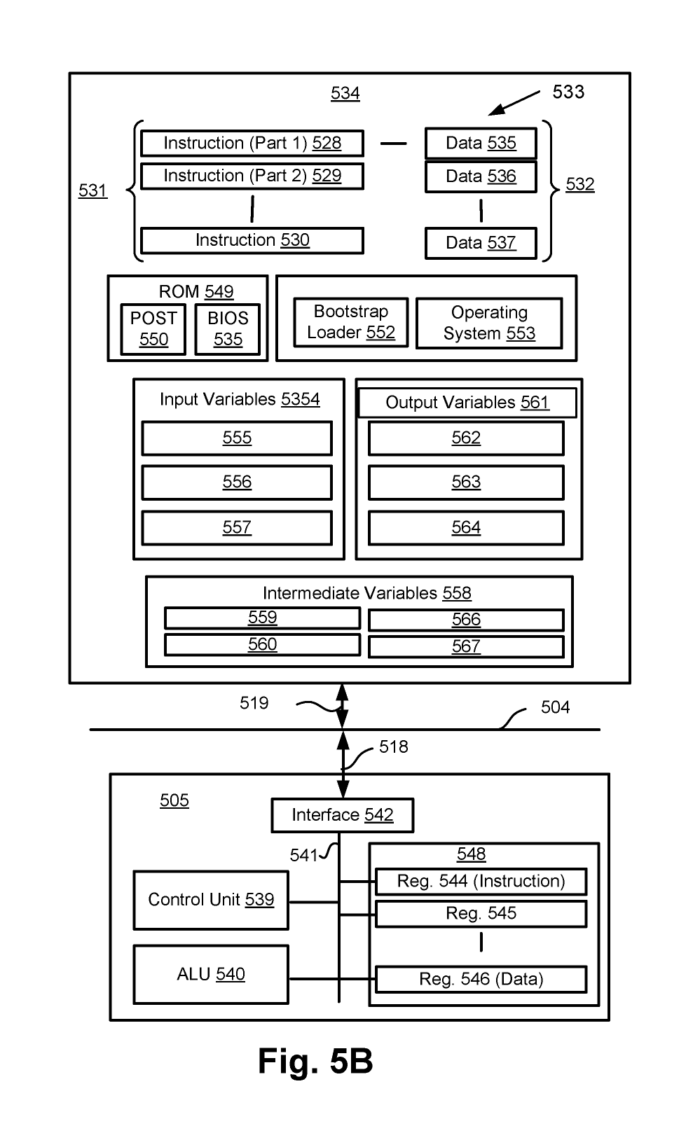

FIG. 1A illustrates a first imaging system 100 for capturing colour intensity information and three-dimensional geometry information about a real-world object 145. The real-world object may be 3D (three-dimensional, i.e. having substantial variation in depth, such as a teapot) or 2.5D (i.e. having deviations about an otherwise flat surface, such as an oil painting). The first imaging system 100 comprises a first camera 110 and a second camera 115 (which can be respectively be implemented by cameras 527, 568 as depicted in FIG. 5A). The first camera 110 images objects in a first frustum 120 (illustrated in FIG. 1A using long dashes). The first camera 110 has a first plane of best focus 130 intersecting the first frustum 120. The location of the first plane of best focus 130 is governed by optical parameters of the first camera 110, most importantly the focal distance. The second camera 115 similarly images objects in a second frustum 125 (illustrated in FIG. 1A using short dashes) and has a second plane of best focus 135. Objects that are present in both the first frustum 120 and the second frustum 125 (that is, in the overlapping region 140) are imaged by both cameras 110, 115. The real-world object 145 is placed near the planes of best focus of the two cameras, and is positioned so that a large portion of the object 145 is in the overlapping region 140. The two cameras 110, 115 of FIG. 1A are geometrically related by a translation in one axis and have similar optical parameters, so the two planes of best focus correspond well in the overlapping region. In other words, two planes of best focus correspond well in the overlapping region if portions of the object 145 that are present in the overlapping region 140 and are in focus for the first camera 110 are also likely to be in focus for the second camera 115.

The real-world object 145 is lit by a lighting arrangement 147 of one or more physical light sources, which may be intentionally placed for the purposes of photography (and may for example consist of one or more studio lights, projectors, photographic flashes, and associated lighting equipment such as reflectors and diffusers), or may be incidentally present (and may for example consist of uncontrolled lighting from the surrounds, such as sunlight or ceiling lights), or some combination of both intentional and incidental. The lighting arrangement 147 defines the distribution of illumination in the region depicted in FIG. 1A and thereby affects the colour intensity information captured by the first camera 110 and the second camera 115 from the object 145.

The two cameras 110, 115, however, do not necessarily need to be related by a translation in one axis only as shown in FIG. 1A. Alternatively, the two cameras 110, 115 can be handheld, i.e. no geometrical constraints are imposed on relative positions on the cameras. An alternative imaging system where the current invention can be practiced is described with references to FIG. 1B.

FIG. 1B illustrates a second imaging system 150 which, similarly to the first imaging system 100, has a first camera 160 with a first imaging frustum 170 and a first plane of best focus 180, and a second camera 165 with a second imaging frustum 175 and a second plane of best focus 185, and has a lighting arrangement 197 of one or more physical light sources. The second imaging system 150 is also arranged to capture images of the object 145, however the object 145 has been omitted from FIG. 1B for simplicity. The first camera 160 and the second camera 165 can be respectively be implemented by the cameras 527, 568 as depicted in FIG. 5A. However, unlike the first imaging system 100, the second imaging system 150 has cameras with respective poses which differ in multiple dimensions (involving both translation and rotation), such as may arise from handheld operation of the cameras. The resulting overlapping region 190 has a different shape to the overlapping region 140 of the first imaging system 100 of FIG. 1A. Further, portions of the object 145 that are present in the overlapping region 190 that are in focus for the first camera 160 may not be in focus for the second camera 165. The lighting arrangement 197 defines the distribution of illumination in the region depicted in FIG. 1B and thereby affects the colour intensity information captured by the first camera 160 and the second camera 165 from the object 145 (not shown).

Although the imaging systems 100 and 150 each show two cameras in use, additional cameras may be used to capture additional views of the object in question. Further, instead of using multiple cameras to capture the views of the object, a single camera may be moved in sequence to the various positions and thus capture the views in sequence. For ease of description, the methods and systems described hereinafter are described with reference to the two camera arrangements depicted either in FIGS. 1A or 1B, each camera being located in a single position.

Each camera is configured to capture images of the object in question containing both colour information and depth information. Colour information is captured using digital photography, and depth information (that is, the distance from the camera to the nearest surface along a ray) is captured using methods such as time-of-flight imaging, stereo-pair imaging to calculate object disparities, or imaging of projected light patterns. The depth information is represented by a spatial array of values called a depth map. The depth information may be produced at a different (lower) resolution to the colour information, in which case the depth map is interpolated to match the resolution of the colour information.

If necessary, the depth information is registered to the colour information. The depth measurements are combined with a photographic image of the scene to form an RGB-D image of the object in question (i.e. RGB denoting the colour intensity channels Red, Green, and Blue of the photographic image, and D denoting the measured depth of the scene and indicating the three-dimensional geometry of the scene), such that each pixel of the resulting image of the object in question has a paired colour value representing visible light from a viewpoint, and a depth value representing the distance from that same viewpoint. Other representations and colour spaces may also be used for an image. For example, the depth information may alternatively be represented as “height” values, i.e. distances in front of a reference distance, stored in spatial array called a height map. The imaging systems 100 and 150 capture respective RGB-D images of the object in question which are unaligned. In order to combine the images captured by such an imaging system, the images are aligned in a manner that is substantially resilient to intensity variations that are present when the images are captured due to different camera poses of cameras 110, 115 (or 160, 165) with respect to the captured object 145 and with respect to the lighting arrangements 147 (or 197). For instance, where the object in question is too large to be captured in a single image at a sufficient surface resolution for the purposes of the intended application (for example, cultural heritage imaging and scientific imaging may require the capture of fine surface details and other applications may not), the object may instead be captured by multiple images containing partially overlapping surface regions of the object. Once these images are aligned, they have corresponding image content at corresponding coordinates. The aligned images are stitched together to form a combined image containing all surface regions that are visible in the multiple images.

### Overview

A lighting arrangement imparts shading to the surface of a thereby lit object. The specific shading that arises is the result of an interaction between the lighting arrangement, the 3D geometry of the object, and material properties of the object (such as reflectance, translucency, colour of the object, and so on). When a directional light source is present, protrusions on the surface of the object can occlude light impinging on surface regions behind the protrusions (that is, behind with respect to the direction of the light source). Thus a lighting arrangement affects intensity images captured of a thereby lit object. In turn, the accuracy of alignment methods using intensity images is affected by the lighting arrangement under which the intensity images are captured.

FIGS. 5A and 5B depict a general-purpose computer system 500, upon which the various DIFE arrangements described can be practiced.

As seen in FIG. 5A, the computer system 500 includes: a computer module 501; input devices such as a keyboard 502, a mouse pointer device 503, a scanner 526, cameras 527, 568, and a microphone 580; and output devices including a printer 515, a display device 514 and loudspeakers 517. An external Modulator-Demodulator (Modem) transceiver device 516 may be used by the computer module 501 for communicating to and from a communications network 520 via a connection 521. The communications network 520 may be a wide-area network (WAN), such as the Internet, a cellular telecommunications network, or a private WAN. Where the connection 521 is a telephone line, the modem 516 may be a traditional “dial-up” modem. Alternatively, where the connection 521 is a high capacity (e.g., cable) connection, the modem 516 may be a broadband modem. A wireless modem may also be used for wireless connection to the communications network 520.

The computer module 501 typically includes at least one processor unit 505, and a memory unit 506. For example, the memory unit 506 may have semiconductor random access memory (RAM) and semiconductor read only memory (ROM). The computer module 501 also includes an number of input/output (I/O) interfaces including: an audio-video interface 507 that couples to the video display 514, loudspeakers 517 and microphone 580; an I/O interface 513 that couples to the keyboard 502, mouse 503, scanner 526, cameras 527, 568 and optionally a joystick or other human interface device (not illustrated); and an interface 508 for the external modem 516 and printer 515. In some implementations, the modem 516 may be incorporated within the computer module 501, for example within the interface 508. The computer module 501 also has a local network interface 511, which permits coupling of the computer system 500 via a connection 523 to a local-area communications network 522, known as a Local Area Network (LAN). As illustrated in FIG. 5A, the local communications network 522 may also couple to the wide network 520 via a connection 524, which would typically include a so-called “firewall” device or device of similar functionality. The local network interface 511 may comprise an Ethernet circuit card, a Bluetooth® wireless arrangement or an IEEE 802.11 wireless arrangement; however, numerous other types of interfaces may be practiced for the interface 511.

The I/O interfaces 508 and 513 may afford either or both of serial and parallel connectivity, the former typically being implemented according to the Universal Serial Bus (USB) standards and having corresponding USB connectors (not illustrated). Storage devices 509 are provided and typically include a hard disk drive (HDD) 510. Other storage devices such as a floppy disk drive and a magnetic tape drive (not illustrated) may also be used. An optical disk drive 512 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 500.

The components 505 to 513 of the computer module 501 typically communicate via an interconnected bus 504 and in a manner that results in a conventional mode of operation of the computer system 500 known to those in the relevant art. For example, the processor 505 is coupled to the system bus 504 using a connection 518. Likewise, the memory 506 and optical disk drive 512 are coupled to the system bus 504 by connections 519. Examples of computers on which the described arrangements can be practised include IBM-PC's and compatibles, Sun Sparcstations, Apple Mac™ or like computer systems.

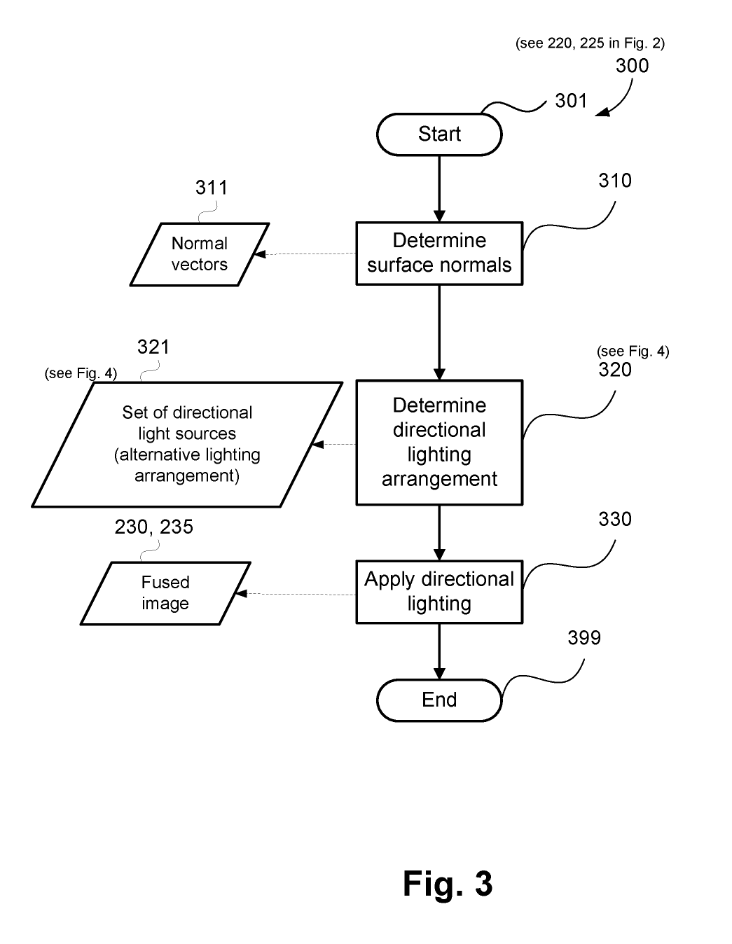

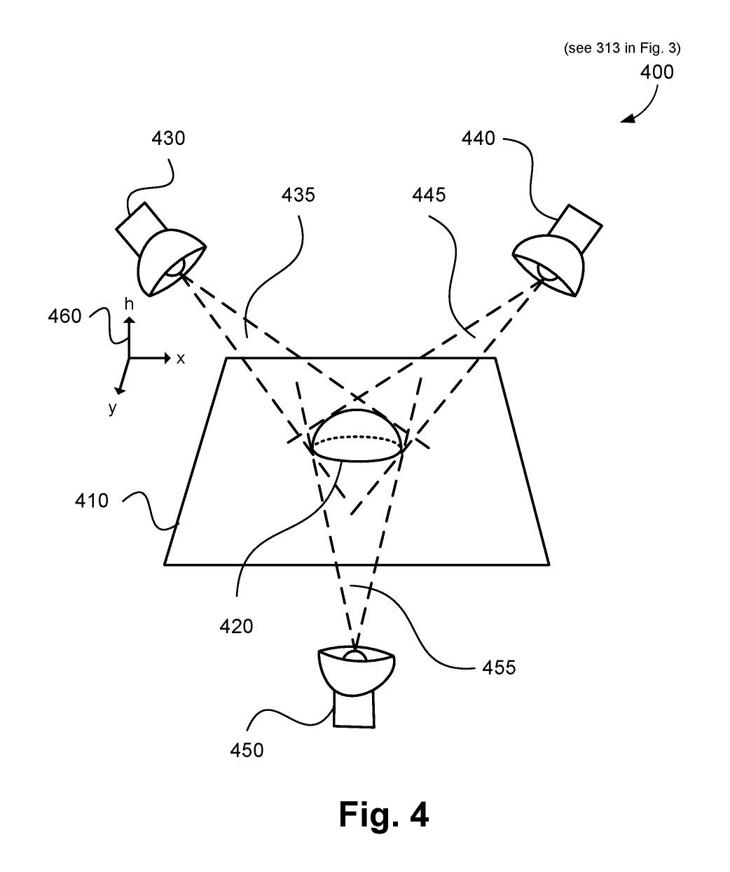

The DIFE method may be implemented using the computer system 500 wherein the processes of FIGS. 2 and 3, to be described, may be implemented as one or more software application programs 533 executable within the computer system 500. In particular, the steps of the DIFE method are effected by instructions 531 (see FIG. 5B) in the software 533 that are carried out within the computer system 500. The software instructions 531 may be formed as one or more code modules, each for performing one or more particular tasks. The software may also be divided into two separate parts, in which a first part and the corresponding code modules performs the DIFE methods and a second part and the corresponding code modules manage a user interface between the first part and the user.

The software may be stored in a computer readable medium, including the storage devices described below, for example. The software is loaded into the computer system 500 from the computer readable medium, and then executed by the computer system 500. A computer readable medium having such software or computer program recorded on the computer readable medium is a computer program product. The use of the computer program product in the computer system 500 preferably effects an advantageous DIFE apparatus.

The software 533 is typically stored in the HDD 510 or the memory 506. The software is loaded into the computer system 500 from a computer readable medium, and executed by the computer system 500. Thus, for example, the software 533 may be stored on an optically readable disk storage medium (e.g., CD-ROM) 525 that is read by the optical disk drive 512. A computer readable medium having such software or computer program recorded on it is a computer program product. The use of the computer program product in the computer system 500 preferably effects a DIFE apparatus.

In some instances, the application programs 533 may be supplied to the user encoded on one or more CD-ROMs 525 and read via the corresponding drive 512, or alternatively may be read by the user from the networks 520 or 522. Still further, the software can also be loaded into the computer system 500 from other computer readable media. Computer readable storage media refers to any non-transitory tangible storage medium that provides recorded instructions and/or data to the computer system 500 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 501. Examples of transitory or non-tangible computer readable transmission media that may also participate in the provision of software, application programs, instructions and/or data to the computer module 501 include radio or infra-red transmission channels as well as a network connection to another computer or networked device, and the Internet or Intranets including e-mail transmissions and information recorded on Websites and the like.

The second part of the application programs 533 and the corresponding code modules mentioned above may be executed to implement one or more graphical user interfaces (GUIs) to be rendered or otherwise represented upon the display 514. Through manipulation of typically the keyboard 502 and the mouse 503, a user of the computer system 500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 517 and user voice commands input via the microphone 580.

FIG. 5B is a detailed schematic block diagram of the processor 505 and a “memory” 534. The memory 534 represents a logical aggregation of all the memory modules (including the HDD 509 and semiconductor memory 506) that can be accessed by the computer module 501 in FIG. 5A.

When the computer module 501 is initially powered up, a power-on self-test (POST) program 550 executes. The POST program 550 is typically stored in a ROM 549 of the semiconductor memory 506 of FIG. 5A. A hardware device such as the ROM 549 storing software is sometimes referred to as firmware. The POST program 550 examines hardware within the computer module 501 to ensure proper functioning and typically checks the processor 505, the memory 534 (509, 506), and a basic input-output systems software (BIOS) module 551, also typically stored in the ROM 549, for correct operation. Once the POST program 550 has run successfully, the BIOS 551 activates the hard disk drive 510 of FIG. 5A. Activation of the hard disk drive 510 causes a bootstrap loader program 552 that is resident on the hard disk drive 510 to execute via the processor 505. This loads an operating system 553 into the RAM memory 506, upon which the operating system 553 commences operation. The operating system 553 is a system level application, executable by the processor 505, to fulfil various high level functions, including processor management, memory management, device management, storage management, software application interface, and generic user interface.

The operating system 553 manages the memory 534 (509, 506) to ensure that each process or application running on the computer module 501 has sufficient memory in which to execute without colliding with memory allocated to another process. Furthermore, the different types of memory available in the system 500 of FIG. 5A must be used properly so that each process can run effectively. Accordingly, the aggregated memory 534 is not intended to illustrate how particular segments of memory are allocated (unless otherwise stated), but rather to provide a general view of the memory accessible by the computer system 500 and how such is used.

As shown in FIG. 5B, the processor 505 includes a number of functional modules including a control unit 539, an arithmetic logic unit (ALU) 540, and a local or internal memory 548, sometimes called a cache memory. The cache memory 548 typically includes a number of storage registers 544-546 in a register section. One or more internal busses 541 functionally interconnect these functional modules. The processor 505 typically also has one or more interfaces 542 for communicating with external devices via the system bus 504, using a connection 518. The memory 534 is coupled to the bus 504 using a connection 519.

The application program 533 includes a sequence of instructions 531 that may include conditional branch and loop instructions. The program 533 may also include data 532 which is used in execution of the program 533. The instructions 531 and the data 532 are stored in memory locations 528, 529, 530 and 535, 536, 537, respectively. Depending upon the relative size of the instructions 531 and the memory locations 528-530, a particular instruction may be stored in a single memory location as depicted by the instruction shown in the memory location 530. Alternately, an instruction may be segmented into a number of parts each of which is stored in a separate memory location, as depicted by the instruction segments shown in the memory locations 528 and 529.

In general, the processor 505 is given a set of instructions which are executed therein. The processor 505 waits for a subsequent input, to which the processor 505 reacts to by executing another set of instructions. Each input may be provided from one or more of a number of sources, including data generated by one or more of the input devices 502, 503, data received from an external source across one of the networks 520, 502, data retrieved from one of the storage devices 506, 509 or data retrieved from a storage medium 525 inserted into the corresponding reader 512, all depicted in FIG. 5A. The execution of a set of the instructions may in some cases result in output of data. Execution may also involve storing data or variables to the memory 534.

The disclosed DIFE arrangements use input variables 554, which are stored in the memory 534 in corresponding memory locations 555, 556, 557. The DIFE arrangements produce output variables 561, which are stored in the memory 534 in corresponding memory locations 562, 563, 564. Intermediate variables 558 may be stored in memory locations 559, 560, 566 and 567.

Referring to the processor 505 of FIG. 5B, the registers 544, 545, 546, the arithmetic logic unit (ALU) 540, and the control unit 539 work together to perform sequences of micro-operations needed to perform “fetch, decode, and execute” cycles for every instruction in the instruction set making up the program 533. Each fetch, decode, and execute cycle comprises:
a fetch operation, which fetches or reads an instruction 531 from a memory location 528, 529, 530;
a decode operation in which the control unit 539 determines which instruction has been fetched; and
an execute operation in which the control unit 539 and/or the ALU 540 execute the instruction.

Thereafter, a further fetch, decode, and execute cycle for the next instruction may be executed. Similarly, a store cycle may be performed by which the control unit 539 stores or writes a value to a memory location 532.

Each step or sub-process in the processes of FIGS. 2 and 3 is associated with one or more segments of the program 533 and is performed by the register section 544, 545, 547, the ALU 540, and the control unit 539 in the processor 505 working together to perform the fetch, decode, and execute cycles for every instruction in the instruction set for the noted segments of the program 533.

The DIFE method may alternatively be implemented in dedicated hardware such as one or more integrated circuits performing the DIFE functions or sub functions. Such dedicated hardware may include graphic processors, digital signal processors, or one or more microprocessors and associated memories.

FIG. 2 shows an alignment method 200 which constructs an auxiliary lighting arrangement involving virtual directional light sources 321 which facilitates alignment of intensity images of an object, and enables alignment and combining images under this auxiliary lighting arrangement. At the start 201 of the alignment method 200, performed by the processor 505 executing the DIFE software 533, a first RGB-D image 210 and a second RGB-D image 215 of an object in question are received. These images may be produced by the imaging system 100 of FIG. 1A or the imaging system 150 of FIG. 1B. These images are captured under, and reflect, the first lighting arrangement, e.g. 147, that affects the colour intensity information of the images. The first RGB-D image 210 and the second RGB-D 215 image are RGB-D images of a particular object of interest such as the real world object 145.

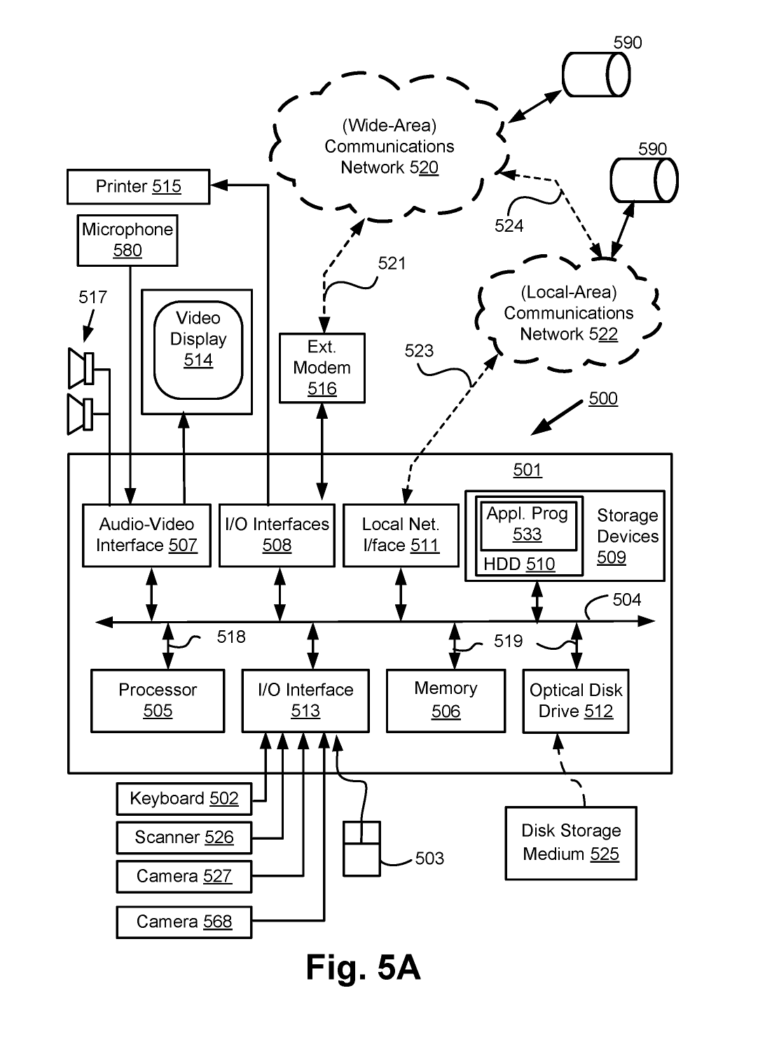

A first fusing step 220 (also referred to as a synthesising step) applies an auxiliary lighting arrangement involving virtual directional light sources 321 (described hereinafter in regard to FIGS. 3 and 4), to the first RGB-D image 210, thereby imparting alternative or additional shading to (ie modulating or modifying) the colour intensity (RGB) information of the first RGB-D image 210 as a result of the auxiliary lighting arrangement 321 and the three-dimensional geometric (D) information of the first RGB-D image 210. Thus the colour intensity information of the first RGB-D image 210 of the object in question and the geometric information of the first RGB-D image 210 of the object in question illuminated by the auxiliary lighting arrangement are referred to as being fused (described hereinafter in more detail with reference to FIG. 3). This is because the geometric information in the RGB-D image of the object in question is used, through its effect on the application of the auxiliary directional lighting arrangement, to modify the colour intensity information of the image of the object in question. The first fusing step 220 produces a first fused intensity image 230 of the object 145 from the first RGB-D image 210. In a similar manner, a second fusing step 225 produces a second fused intensity image 235 of the object 145 from the second RGB-D image 215.

The first fused image 230 of the object 145 and the second fused image 235 of the object 145 are aligned by an alignment step 240, performed by the processor 505 executing the DIFE software 533, producing a first mapping 250 from the coordinate space of the first fused image to a consistent coordinate space and a second mapping 255 from the coordinate space of the second fused image to a consistent coordinate space. Typically the first mapping is the identity mapping (that is, the mapping that does not alter the coordinate space), and the second mapping is a mapping from the coordinate space of the second fused image onto the coordinate space of the first fused image. In this case, the first mapping may be implicit, i.e. the mapping would be an identity mapping. In other words, in the typical case no first mapping is created as such, and the first mapping is implied to be an identity mapping.

The first mapping 250 is depicted in FIG. 2 for the sake of generality. As noted above, in practice this mapping is typically an implicit (ie identity) mapping. This is because typically it is desired to map one image onto the coordinate space of the other image, because in that way only one image has to be warped. In that typical case the first mapping would not be performed.

The alignment step 240 is described in more detail hereinafter with reference to equation [11] in the section entitled “Alignment”. Multi-modal alignment (described hereinafter in the “Alignment” section) is preferably used in the step 240, because there are likely to be differences in camera poses used to capture the input images 210, 215 and therefore the colours caused by the auxiliary virtual directional lighting will be different between the images, and traditional gradient-based alignment methods may be inadequate.

Since the first fused image 230 of the object 145 is in the same coordinate space as the first RGB-D image 210 of the object 145 and the second fused image 235 of the object 145 is in the same coordinate space as the second RGB-D image 215 of the object 145, the first mapping 250 and the second mapping 255 that map the coordinate spaces of the fused images of the object 145 to a consistent coordinate space likewise map the coordinate spaces of the RGB-D images of the object 145 to that consistent coordinate space.

An image combining step 260, performed by the processor 505 executing the DIFE software 533, uses the first mapping 250 and the second mapping 255 to map the first RGB-D image 210 of the object 145 and the second RGB-D image 215 of the object 145 to a combined image 270 in a consistent coordinate space. As previously noted, the term “consistent coordinate space” refers to a coordinate space in which corresponding image content in a pair of images occurs at the same coordinates.

As the result of alignment, corresponding image content in the first RGB-D image 210 and the second RGB-D image 215 is located, with higher accuracy than is typically achievable with traditional approaches, at corresponding coordinates in the consistent coordinate space. Thus image content from the RGB-D images of the object 145 can be combined, for example by stitching the RGB-D images of the object 145 together, or by determining the diffuse colour of an object such as the object 145 captured in the images. This results in the combination 270 derived using the first RGB-D image 210 and the second RGB-D image 215. This denotes the end 299 of the alignment method 201.

### Auxiliary Lighting Arrangement Using Virtual Directional Light Sources

FIG. 3 depicts an example of a fusing method 300, performed by the processor 505 executing the DIFE software 533, for fusing intensity information and three-dimensional geometric information in an RGB-D image. This fusing method 300 can be used by the first fusing step 220 and the second fusing step 225 of FIG. 2.

Following the start 301 of the fusing method 300, referring only to the first RGB-D image 210 for simplicity of description, a surface normal determination step 310, performed by the processor 505 executing the DIFE software 533, uses the geometric information (e.g. the depth map information stored in the pixels of the RGB-D image 210) to determine normal vectors 311 at the pixel coordinates of the first RGB-D image 210. The normal vectors point directly away (at 90 degrees) from the surface of the object whose image has been captured in the first RGB-D image 210. (The normal vector at an object surface position is orthogonal to the tangent plane about that object surface position.)

According to an arrangement of the described DIFE methods, the geometric information is a height map. In this arrangement the surface normal determination step 310 first determines gradients of the height with respect to x and y (x and y being horizontal and vertical pixel axes respectively of the height map). These gradients are determined by applying an x gradient filter (−1 0 1) and a y gradient filter

$$( \begin{matrix}- 1 \\ 0 \\ 1\end{matrix} )$$

respectively to the height map by convolution, as shown in equation [2] as follows,

$$\frac{\partial h}{\partial x} = ( \begin{matrix}- 1 & 0 & 1\end{matrix} ) * H ; \frac{\partial h}{\partial y} = ( \begin{matrix}- 1 \\ 0 \\ 1\end{matrix} ) * H , \qquad [ 2 ]$$

where h is the height axis,

$$\frac{\partial h}{\partial x}$$

is the gradient of the height with respect to x,

$$\frac{\partial h}{\partial y}$$

is the gradient of the height with respect to y, * is the convolution operator, and H is the height map. According to equation [2], gradients of the height are determined at each pixel by measuring the difference of height values of neighbouring pixels on either side of that pixel in the x or y dimension. Thus the gradients of the height represent whether the height is increasing or decreasing with a local change in x or y, and also the magnitude of that increase or decrease.

Then normal vectors are determined as follows as depicted in equation in [3]:

$$n = ( \begin{matrix}1 & 0 & \frac{\partial h}{\partial x}\end{matrix} ) \times ( \begin{matrix}0 & 1 & \frac{\partial h}{\partial y}\end{matrix} ) = ( \begin{matrix}\begin{matrix}\frac{- \partial h}{\partial x} & \frac{- \partial h}{\partial y}\end{matrix} & 1\end{matrix} ) , \qquad [ 3 ]$$

where n is a normal vector, h is the height axis,

$$\frac{\partial h}{\partial x}$$

is an x gradient of the height map at a surface position,

$$\frac{\partial h}{\partial y}$$

is the y gradient of the height map at that same surface position, and x is the cross product operator. Equation [3] determines a normal vector as being a vector orthogonal to the tangent plane about a surface point, where the tangent plane is specified using the gradient of the height with respect to x and y at that surface point as described earlier. Finally the normal vectors are normalised by dividing them by their length, resulting in normal vectors of unit length representing the normal directions.

A following step 320, performed by the processor 505 executing the DIFE software 533, selects an auxiliary directional lighting arrangement 321, one such arrangement being described hereinafter in more detail with reference to FIG. 4. An auxiliary directional lighting arrangement is described by a set of virtual directional light sources, each such light source being associated with a pose (e.g. position and orientation), an intensity (possibly having multiple components, e.g. having a diffuse intensity component and a specular intensity component), and other characterising attributes such as a colour. Auxiliary directional lighting is used to introduce directional shading that can be useful as a signal for alignment, especially for objects that do not have much visible texture (i.e. intensity variation) but do have some geometric variation.

FIG. 4 illustrates a particular auxiliary directional lighting arrangement 400 that may be used to generate the first fused image 230 and the second fused image 235. The auxiliary lighting arrangement 400 is preferred for an object (such as the object depicted in FIG. 4 which has a surface 410 with a rounded protrusion 420) with a typical natural scene texture in the first and second captured RGB-D images. A scene texture is considered natural if the intensity gradients in the texture image have a relatively even distribution of orientations. A set of coordinate axes 460 indicate the x, y and h axes. The object has a surface 410 with a rounded protrusion 420. Preferably, three virtual directional light sources 430, 440 and 450 are used. The light sources are considered to be virtual because they are not physically positioned with respect to the object, only parameters defining the virtual light sources are used to generate fused images, for example, by applying suitable rendering techniques to the colour intensity information and the geometric information of a corresponding RGB-D image illuminated by the auxiliary lighting arrangement 400.

The first virtual directional light source 430 illuminates a first region 435 (indicated with dashed lines) with red light. The second virtual directional light source 440 illuminates a second region 445 (indicated with dashed lines) with green light. The third virtual directional light source 450 illuminates a third region 455 (indicated with dashed lines) with blue light. The three virtual lights are positioned in an elevated circle above the object's surface 410 and are evenly distributed around the circle such that each virtual light source is 120° away from the other two virtual light sources. The position of the virtual light sources is set so that the distance from the object surface to the virtual light source is large in comparison to the width of the visible object surface, such as 10 times the width. Alternatively, for the purpose of generating fused images, the position of the virtual light sources can be set to be an infinite distance from the object, such that only the angle of the virtual light source with respect to the object surface is used in the directional lighting application step 330, described below. The virtual light sources are tilted down towards the object's surface 410.

As a result, each virtual light source illuminates a portion of the surface of the protrusion 420, and the portions illuminated by adjacent virtual light sources partially overlap. As a result, the surface of the protrusion is illuminated by a mixture of coloured lights. Although the light colours have been described as red, green and blue respectively, other primary colours such as cyan, magenta and yellow may be used. The three virtual directional light sources 430, 440 and 450, having orientations according to the geometry shown in FIG. 4, colours as described above, and the same intensity (e.g. 50% of the intensity that would cause the maximal exposure that can be represented by the intensity information), constitute the selected auxiliary directional lighting arrangement being considered in this example. When this auxiliary directional lighting arrangement is applied by a later step 330, it result in a mixture of coloured light intensities reflected by the object 410/420.

Other auxiliary directional lighting arrangements, may alternatively be used. For instance, according to a further directional lighting arrangement (not shown), auxiliary directional lighting is applied to modulate the intensity in regions of the RGB-D image 210 that have small intensity variations. In particular, this arrangement is preferred when small intensity variations are present in the captured RGB-D images that may be associated with dark regions, for example regions that are shadowed due to the capture-time lighting arrangement 147. This auxiliary arrangement is also preferred when the captured RGB-D images contain significant asymmetry in the orientations of intensity variations. An auxiliary directional lighting arrangement is determined that illuminates from the direction of least intensity variation. To determine this direction, a histogram of median intensity variation with respect to surface normal angle is created. For each surface position having integer-valued (x,y) coordinates, the local intensity variation is calculated as follows according to equation [4], which calculates the gradient magnitude of intensities in a local region, quantifying the amount of local intensity variation:

$$\vert ∇ I \vert = \sqrt{\frac{\partial {I}^{2}}{\partial x} + \frac{\partial {I}^{2}}{\partial y}} , \qquad [ 4 ]$$

where I is the intensity data, |∇I| is the local intensity variation at the surface position,

$$\frac{\partial I}{\partial x}$$

is the x intensity gradient determined as follows in [5]:

$$\frac{\partial I}{\partial x} = ( \begin{matrix}- 1 & 0 & 1\end{matrix} ) * I , \qquad [ 5 ]$$

and

$$\frac{\partial I}{\partial y}$$

is the y intensity gradient determined as follows in [6]:

$$\frac{\partial I}{\partial y} = ( \begin{matrix}- 1 \\ 0 \\ 1\end{matrix} ) * I . \qquad [ 6 ]$$

Equations [5] and [6] calculate gradients of the intensity with respect to x and y by measuring the difference of intensity values of neighbouring pixels on either side of that pixel in the x or y dimension. Thus the gradients of the intensity represent whether the intensity is increasing or decreasing with a local change in x or y, and also the magnitude of that increase or decrease.

Normal vectors are calculated as described previously with reference to equation [3], and the rotation angle of each normal vector is determined. From these rotation angles, the histogram is created to contain the sum of local intensity variation |∇I| for surface positions having rotation angles that fall within bins of rotation angles (e.g. with each bin representing a 1° range of rotation angles). Then the 30° angular domain having the least sum of local intensity variation is determined from the histogram. A virtual directional light source is created having a rotation direction equal to the central angle of this 30° angular domain. A “real” rather than a “virtual” directional light source can be used, however it is simpler to implement a virtual light source. An elevation angle of this directional light source can be determined using a similar histogram using elevation angles instead of rotation angles. A directional light source may be created for each colour channel separately, with each such light source having the same colour as the associated colour channel. The intensities of the light sources are selected so as not to exceed the maximum exposure that can be digitally represented by the intensity information of the pixels in the fused image. The aforementioned maximum exposure is considered with reference to the intensity of the image. Thus, for example, if the image intensity is characterised by 12 bit intensity values, it is desirable to avoid saturating the pixels with values above 2¹². Where the regions of small intensity variation correspond with dark intensities (e.g. due to shadowing), the intensity values in these regions are increased. As described below with reference to Equation [7], the intensity data is used as diffuse surface colours, and thus increasing the intensity values in these regions increases the impact of the directional shading in these regions.

Alternatively, an elevation angle of a directional light source is determined according to a maximum shadow distance constraint corresponding to the longest shadow length that should be created by the auxiliary lighting arrangement as applied to the object in question (for instance, 10 pixels). The shadow lengths can be calculated using shadow mapping based on ray tracing from the virtual directional light source. Shadow mapping is described in more detail below. The shadow length of each shadowed ray in fused image pixel coordinates can be calculated from the distance between the object surface intersection points of a ray suffering from occlusion. The maximum shadow distance is the maximum of the shadow lengths for all rays from the virtual directional light source.

A following auxiliary directional lighting application step 330, performed by the processor 505 executing the DIFE software 533, applies the auxiliary directional lighting arrangement 321 determined in the step 320 to the first RGB-D image 210 by virtually simulating the effect of the auxiliary directional lighting arrangement on the object in question, to thereby modulate the intensity information contained in the first RGB-D image 210 and thus produce the fused image 230. The virtual simulation of the effect of the auxiliary directional lighting arrangement on the object in question to generate the fused image 230 effectively renders the colour intensity information and the geometric information of a corresponding RGB-D image illuminated by the virtual light sources. Rendering of the colour intensity information and the geometric information illuminated by the virtual light sources can be done using different reflection models. For example, a Lambertian reflection model, a Phong reflection model or any other reflection model can be used to fuse the colour intensity information and the geometric information illuminated by virtual light sources.

According to a DIFE arrangement, the step 330 can use a Lambertian reflection model representing diffuse reflection. According to Lambertian reflection, the intensity of light reflected by an object I_{R,LAMBERTIAN} from a single light source is given by the following equation in [7]:

I_{R,LAMBERTIAN}=I_{LD}(n·L)C_{D}, [7]

where I_{LD} is the diffuse intensity of that virtual light source, n is the surface normal vector at the surface reflection position, L is the normalised vector representing the direction from the surface reflection position to the light source, C_{D} is the diffuse colour of the surface at the surface reflection position, and · is the dot product operator. According to equation [7], light from the virtual light source impinges the object and is reflected back off the object in directions orientated more towards the light source than away from it, with the intensity of reflected light being greatest for surfaces directly facing the light source and reduced for surfaces oriented obliquely to the light source.

The Lambertian reflection value is calculated for each pixel in the first RGB-D image and for each of the 3 RGB colour channels. The diffuse light intensities can have different values in each of the RGB colour channels in order to produce the effect of a coloured light source, such as a red, green or blue light source. The diffuse colour of the surface C_{D} is taken from the RGB channels of the first RGB-D image.

Due to the dot product, the intensity of reflected light falls off according to cos(θ), where θ is the angle between the surface normal n and the light direction L. When multiple light sources illuminate a surface, the corresponding overall reflection is the sum of the individual reflections from each single light source. The diffuse colour C_{D} is the same colour as the intensity information at each surface reflection position. The auxiliary directional lighting application step 330 uses the surface normal vectors 311 determined from the geometric data of the first RGB-D image 210, and modulates the intensity data of the RGB-D image 210 according to Lambertian reflection of the determined auxiliary directional lighting arrangement 321, thereby producing a corresponding fused intensity image 230.

Thus the surface protrusion 420 is lit by different colours at different angles of the x-y plane, resulting in a “colour wheel” effect. Accordingly, in this DIFE arrangement the auxiliary directional lighting application step 330 modulates the intensity data of the first RGB-D image 210 according to Lambertian reflection to thereby produce the fused RGB image 230.

According to another arrangement of the described DIFE methods, a Phong reflection model representing both diffuse and specular reflection is used in the application step 330. According to Phong reflection, the intensity of light reflected by an object I_{R,PHONG} due to a single light source is given by the following equation [8]:

I_{R,PHONG}=I_{RD}+I_{RS}, [8]

where I_{RD} is the intensity of diffusely reflected light and I_{RS} is the intensity of specularly reflected light due to the light source.

The diffuse reflection is determined according to Lambertian reflection as follows in equation [9]:

I_{RD}=I_{R,LAMBERTIAN}. [9]

The specular reflection is given by the following in equation [10]:

I_{RS}=I_{LS}(Rₛ·V)^{a}^{ₛ}C_{S}, [10]

where I_{LS} is the specular intensity of that light source, Rₛ is the specular reflection angle at the surface reflection position located about the surface normal vector n from the light direction L, that is Rₛ=2n(L·n)−L, V is the viewing vector representing the direction from the surface reflection position to the viewing position, aₛ is the specular concentration of the surface controlling the angular spread of the specular reflection (for example, 32), and C_{S} is the specular colour, typically the same as the colour of the light source. According to equation [10], the specular reflection component of Phong reflection corresponds to a mirror-like reflection (for small values of a_{S}) or a glossy/shiny reflection (for larger values of a_{S}) of the light source that principally occurs at viewing angles that are about the normal angle of a surface from the lighting angle. According to Phong reflection, as with Lambertian reflection, when multiple light sources illuminate a surface, the corresponding overall reflection is the sum of the individual reflections from each single light source. The Phong reflection value is calculated for each pixel in the first RGB-D image and for each of the 3 RGB colour channels. The diffuse and specular light intensities can have different values in each of the RGB colour channels in order to produce the effect of a coloured light source, such as a red, green or blue light source. The diffuse colour of the surface is taken from the RGB channels of the first RGB-D image. Accordingly, in this DIFE arrangement the auxiliary directional lighting application step 330 modulates the intensity data of the first RGB-D image 210 according to Phong reflection of the determined auxiliary directional lighting arrangement 321 to thereby produce the fused RGB image 230.

According to another arrangement of the described DIFE methods, a directional shadowing model representing surface occlusions of the lighting is used. A shadow mapping technique is used to identify surface regions that are in shadow with respect to each virtual directional light source. According to the shadow mapping technique, a depth map is determined from the point of view of each virtual directional light source, indicating the distances to surface regions directly illuminated by the respective light. To determine if a surface region is in shadow with respect to a light source, the position of the surface region is transformed to the point of view of that light source, and the depth of the transformed position is tested against the depth stored in that light source's depth map. If the depth of the transformed position is greater than the depth stored in the light source's depth map, the surface region is occluded with respect to that light source and is therefore not illuminated by that light source. Note that a surface region may be shadowed with respect to one light source but directly illuminated by another light source. This technique produces hard shadows (that is, shadows with a harsh transition between shadowed and illuminated regions), so a soft shadowing technique is used to produce a gentler transition between shadowed and illuminated regions. For instance, each light source is divided into multiple point source lights having respective variations in position and distributed intensity to simulate an area source light. The shadow mapping and illumination calculations are then performed for each of these resulting point source lights. Other soft shadowing techniques may also be employed. As with other arrangements, the intensity data is used as the diffuse colour of the object. In order to retain some visibility of the intensity data in heavily shadowed regions, a white ambient light illuminates the object evenly. The intensity of the ambient light is a small fraction of the total illumination applied (for example, 20%). Thus regions occluded by the surface protrusion 420 have directional shadowing resulting in varying illumination colours at varying surface positions relative to the surface protrusion. Accordingly, in this DIFE arrangement the auxiliary directional lighting application step 330 modulates the intensity data of the first RGB-D image 210 according to a directional shadowing model to thereby produce the fused RGB image 230.

Although the above description has been directed at production of the fused RGB image 230 from the first RGB-D image 210, the description applies equally to production of the fused RGB image 235 from the second RGB-D image 215.

After the application step 330, the method 300 terminates with an End step 399, and control returns to the steps 230, 235 in FIG. 2.

### Alignment

According to an arrangement of the described DIFE methods, the alignment step 240 uses Nelder-Mead optimisation using a Mutual Information objective function, described below in the section entitled “Mutual Information”, to determine a parameterised mapping from the second image to the first image. This step is described for the typical case where the first mapping 250 is implicitly the identity mapping, and the second mapping 255 is a mapping from the coordinate space of the second image onto the coordinate space of the first image. Thus the mapping being determined is the second mapping. The parameterisation of this mapping relates to the anticipated geometric relationship between the two images. For example, the mapping may be parameterised as a relative translation in three dimensions and a relative angle in three axes giving a total of six dimensions which describe the relative viewpoints of the two cameras used to capture the first and second RGB-D images, and which subsequently influence the geometrical relationship between the intensities in the first and second fused images

The Nelder-Mead optimisation method starts at an initial set of mapping parameters, and iteratively alters the mapping parameters to generate new mappings, and tests these mappings to assess the resulting alignment quality. The alignment quality is maximised with each iteration, and therefore a mapping is determined that produces good alignment.

### Mutual Information

The alignment quality associated with a mapping is measured using Mutual Information, a measure of pointwise statistical commonality between two images in terms of information theory. The mapping being assessed (from the second fused image 235 to the first fused image 230) is applied to the second image, and Mutual Information is measured between the first image and the transformed second image. The colour information of each image is quantised independently into 256 colour clusters, for example by using the k-means algorithm, for the purposes of calculating the Mutual Information. Each colour cluster is represented by a colour label (such as a unique integer per colour cluster in that image), and these labels are the elements over which the Mutual Information is calculated. A Mutual Information measure I for a first image containing a set of pixels associated with a set of labels A={aᵢ} and a second image containing a set of pixels associated with a set of labels B={bⱼ}, is defined as follows in Equation [11]:

$$I = {\sum }_{i , j}^{ } P ( {a}_{i} , {b}_{j} ) {log}_{2} ( \frac{P ( {a}_{i} , {b}_{j} )}{P ( {a}_{i} ) P ( {b}_{j} )} ) , \qquad [ 11 ]$$

where P(aᵢ, j_{b}) is the joint probability value of the two labels aᵢ and bⱼ co-occurring at the same pixel position, P(aᵢ) and P(bⱼ) are the marginal probability distribution values of the respective labels aᵢ and bⱼ, and log₂ is the logarithm function of base 2. Further, i is the index of the label aᵢ and j is the index of the label bⱼ. If the product of the marginal probability values P(aᵢ) and P(bⱼ) is zero (0), then such a pixel pair is ignored. According to Equation [11], the mutual information measure quantifies the extent to which labels co-occur at the same pixel position in the two images relative to the number of occurrences of those individual labels in the individual images. Motivationally, the extent of label co-occurrences is typically greater between aligned images than between unaligned images, according to the mutual information measure. In particular, one-dimensional histograms of labels in each image are used to calculate the marginal probabilities of the labels (i.e. P(aᵢ) and P(bⱼ)), and a pairwise histogram of co-located labels are used to calculate the joint probabilities (i.e. P(aᵢ, bⱼ)).

The Mutual Information measure may be calculated only for locations within the overlapping region. The overlapping region is determined for example by creating a mask for the first fused image 230 and second fused image 235, and applying the mapping being assessed to the second image's mask producing a transformed second mask. Locations are only within the overlapping region, and thus considered for the probability distribution, if they are within the intersection of the first mask and the transformed second mask.

Alternatively, instead of creating a transformed second image, the probability distributions for the Mutual Information measure can be directly calculated from the two images 230 and 235 and the mapping being assessed using the technique of Partial Volume Interpolation. According to Partial Volume Interpolation, histograms involving the transformed second image are instead calculated by first transforming pixel positions (that is, integer-valued coordinates) of the second image onto the coordinate space of the first image using the mapping. Then the label associated with each pixel of the second image is spatially distributed across pixel positions surrounding the associated transformed coordinate (i.e. in the coordinate space of the first image). The spatial distribution is controlled by a kernel of weights that sum to 1, centred on the transformed coordinate, for example a trilinear interpolation kernel or other spatial distribution kernels as known in the literature. Then histograms involving the transformed second image are instead calculated using the spatially distributed labels.

The Mutual Information measure of two related images is typically higher when the two images are well aligned than when they are poorly aligned.

### Nelder-Mead Optimisation

The aforementioned Nelder-Mead optimisation method iteratively determines a set of mapping parameters. Each set of mapping parameters corresponds to a simplex in mapping parameter space. Each dimension of the mapping parameter space corresponds to a dimension of the mapping parameterisation. For instance, one dimension of the mapping parameterisation may be yaw angle. Each vertex of the simplex corresponds to a set of mapping parameters. The initial simplex has a vertex corresponding to an initial parameter estimate and an additional vertex per dimension of the mapping parameter space. If no estimate of the initial parameters is available, the initial parameter estimate is zero for each parameter. Each of the additional vertices represents a variation away from the initial parameter estimate along a single corresponding dimension of the mapping parameter space. Thus each additional vertex has a position in parameter space corresponding to the initial parameter estimate plus an offset in the single corresponding dimension. The magnitude of each offset is set to half the expected variation in the corresponding dimension of the mapping parameter space. Other offsets may be used, as the Nelder-Mead optimisation method is robust with respect to starting conditions for many problems.

Each set of mapping parameters corresponding to a vertex of the simplex is evaluated using the aforementioned Mutual Information assessment method. When a Mutual Information measure has been produced for each vertex of the simplex, the Mutual Information measures are tested for convergence. Convergence may be measured in terms of similarity of the mapping parameters of the simplex vertices, or in terms of the similarity of the Mutual Information measures produced for the simplex vertices. The specific numerical thresholds for convergence depend on the alignment accuracy requirements or processing time requirements of the imaging system. Typically, stricter convergence requirements produce better alignment accuracy, but require more optimisation iterations to achieve. As an indicative starting point, a Mutual Information measure similarity threshold of 1e−6 (that is, 10⁻⁶) may be used to define convergence. On the first iteration (i.e. for the initial simplex), convergence is not achieved.

If convergence is achieved, the mapping estimate (or a displacement field) indicative of the best alignment of overlapping regions is selected as the second mapping 255. Otherwise, if convergence is not achieved, a transformed simplex representing a further set of prospective mapping parameters is determined using the Mutual Information measures, and these mapping parameter estimates are likewise evaluated as a subsequent iteration. In this manner, a sequence of simplexes traverses parameter space to determine a refined mapping estimate. To ensure the optimisation method terminates, a maximum number of simplexes may be generated, at which point the mapping estimate indicative of the best alignment of overlapping regions is selected as the second mapping 255. According to this approach the first mapping 250 is the identity mapping.

### Displacement Field Estimation

In an alternative embodiment, the alignment step 240 estimates a displacement field, where the second mapping 255 is an array of 2D vectors called a displacement field. In the displacement field each vector describes the shift for a pixel from the first fused intensity image 230 to the second fused intensity image 235.

The displacement field is estimated by first creating an initial displacement field. The initial displacement field is the identity mapping consisting of a set of (0, 0) vectors. Alternatively, the initial displacement field may be calculated using approximate camera viewpoints measured during image capture. Displacement field estimation then proceeds by assigning colour labels to each pixel in the fused intensity images, using colour clustering as described above. A first pixel is selected in the first fused intensity image, and a second pixel is determined in the second fused intensity image by using the initial displacement field. A set of third pixels is selected from the second fused intensity image, using a 3×3 neighbourhood around the second pixel.

A covariance score is calculated for each pixel in the set of third pixels, which estimates the statistical dependence between the label of the first pixel and the labels of each of the third pixels. The covariance score (C_{i,j}) for labels (aᵢ, bⱼ) is calculated using the marginal and joint histograms determined using Partial Volume Interpolation, as described above. The covariance score is calculated using equation [12]:

$${C}_{i , j} = \frac{P ( {a}_{i} , {b}_{j} )}{P ( {a}_{i} , {b}_{j} ) + P ( {a}_{i} ) P ( {b}_{j} ) + ɛ} \qquad [ 12 ]$$

where P(aᵢ,bⱼ) is the joint probability estimate of labels aᵢ and bⱼ placed at corresponding positions of the first fused intensity image and the second fused intensity image determined based on the joint histogram of the first and second fused intensity images, P(aᵢ) is the probability estimate of the label aᵢ appearing in the first fused image determined based on the marginal histogram of the first fused intensity image, and P(bᵢ) is the probability estimate of the label bⱼ appearing in the second fused image determined based on the histogram of the second fused intensity image. ε is a regularization term to prevent a division-by-zero error, and can be an extremely small value. Corresponding positions for pixels in the first fused image and the second fused image are determined using the initial displacement field. In equation [12], the covariance score is a ratio, where the numerator of the ratio is the joint probability estimate, and the denominator of the ratio is the joint probability estimate added to the product of the marginal probability estimates added to the regularization term.

The covariance score has a value between 0 and 1. The covariance score C_{i,j} takes on values similar to a probability. When the two labels appear in both images, but rarely co-occur, C_{i,j} approaches 0, i.e. P(aᵢ,bⱼ)<<P(aᵢ)P(bⱼ). C_{i,j} is 0.5 where the two labels are statistically independent, i.e. P(aᵢ,bⱼ)=P(aᵢ)P(bⱼ). C_{i,j} approaches 1.0 as the two labels co-occur more often than not, i.e. P(aᵢ,bⱼ)>>P(aᵢ)P(bⱼ).

Candidate shift vectors are calculated for each of the third pixels, where each candidate shift vector is the vector from the second pixel to one of the third pixels.

An adjustment shift vector is then calculated using a weighted sum of the candidate shift vectors for each of the third pixels, where the weight for each candidate shift vector is the covariance score for the corresponding third pixel. The adjustment shift vector is used to update the initial displacement field, so that the updated displacement field for the first pixel becomes a more accurate estimate of the alignment between the first fused intensity image and the second fused intensity image. The process is repeated by selecting each first pixel in the first fused intensity image, and creating an updated displacement field with increased accuracy.

The displacement field estimation method then determines whether the alignment is completed based upon an estimate of convergence. Examples of suitable convergence completion tests are a predefined maximum iteration number, or a predefined threshold value which halts the iteration when the predefined threshold value is larger than the root-mean-square magnitude of the adjustment shift vectors corresponding to each vector in the displacement field. An example threshold value is 0.001 pixels. In some implementations, the predefined maximum iteration number is set to 1. In majority of cases, however, to achieve accurate registration, the maximum iteration number is set to at least 10. For smaller images (e.g. 64×64 pixels) the maximum iteration number can be set to 100. If the alignment is completed, then the updated displacement field becomes the final displacement field. The final displacement field is then used to combine the images in step 260.

### Alternative Arrangement for Surface Geometry

In an alternative arrangement, the captured colour intensity information and 3D geometry information are represented as an image with an associated mesh. In this arrangement, in the first and second captured images 210 and 215 the depth channel is stored as a mesh. The mesh is a set of triangles where the 3D position of each triangle vertex is stored, and the triangles form a continuous surface, known as a mesh. The first and second meshes are aligned with the first and second captured RGB intensity images, for example using a pre-calibrated position and orientation of the distance measuring device with respect to the camera that captures the RGB image intensity. The distance measuring device may be a laser scanner, which records a point cloud using time of flight measurements. The point cloud can be used to estimate a mesh using methods known in the literature as surface reconstruction.

In a further alternative arrangement, the image intensities and geometric information are both captured using a laser scanner which records a point cloud containing an RGB intensity and 3D coordinate for each point in the point cloud. The point cloud may be broken up into sections according to measurements taken with the distance measuring device at different positions, and these point cloud sections then require alignment in order to combine the intensity data in the step 260. A 2D image aligned with each point cloud section is formed by projection onto a plane, for example the best fit plane through the point cloud section.

In the fusing method 300, the surface normal determination step 310 uses the mesh as the source of geometric information to determine the normal vectors 311 at the pixel coordinates of the RGB-D image 210. The normal vectors are determined using the alignment of the mesh to identify the triangle in the mesh which corresponds to the projection of each pixel in the captured RGB image onto the object surface. The vertices of the triangle determine a plane, from which the normal vector can be determined. Alternatively, the pixel normal angle can be interpolated from the normal angles of several mesh triangles that are in the neighbourhood of the closest mesh triangle.

### Concluding Remarks

The described DIFE methods fuse three-dimensional geometry data with intensity data using auxiliary directional lighting to produce a fused image. As a result, the colours of the fused image vary with respect to the three-dimensional geometry, such as normal angle variation and surface occlusions, of the object being imaged. Techniques for aligning such fused images hence align geometry and intensity concurrently.

### INDUSTRIAL APPLICABILITY

The arrangements described are applicable to the computer and data processing industries and particularly for the image processing industry.

The foregoing describes only some embodiments of the present invention, and modifications and/or changes can be made thereto without departing from the scope and spirit of the invention, the embodiments being illustrative and not restrictive.

1. A method of combining object data captured from an object, the method comprising:
receiving first object data and second object data, the first object data comprises first intensity image data and first three-dimensional geometry data of the object and the second object data comprises second intensity image data and second three-dimensional geometry data of the object;
synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data;
aligning the first fused image and the second fused image; and
combining the first object data and the second object data.

2. The method according to claim 1, wherein the synthesising step comprises the steps of:
determining normal vectors at pixel locations in the first intensity image data and the second image intensity data of the object dependent upon the first three-dimensional geometry data and the second three-dimensional geometry data of the object; and
applying the directional lighting arrangement to the respective first intensity image data and the second intensity image data, dependent upon the normal vectors, to form the first fused image and the second fused image.

3. The method according to claim 2, wherein the applying step comprises modulating the first intensity image data and the second intensity image data using the directional lighting arrangement in accordance with Lambertian reflection.

4. The method according to claim 2, wherein the applying step comprises modulating the first intensity image data and the second intensity image data using the directional lighting arrangement in accordance with Phong reflection.

5. The method according to claim 2, wherein the applying step comprises modulating the first intensity image data and the second intensity image data using directional shadowing produced by the directional lighting arrangement interacting with the corresponding three-dimensional geometry data.

6. The method according to claim 1, wherein the aligning step comprises applying a multi-modal alignment method to the first fused image and the second fused image.

7. The method according to claim 1, wherein the alignment step comprises determining a displacement field based on marginal probabilities of labels in the first fused image and the second fused image and joint probabilities of labels located at corresponding positions of the first fused image and the second fused image.

8. The method according to claim 1, wherein the directional lighting arrangement provides additional intensity variations in areas of low texture in the intensity image data based on the three-dimensional geometry data.

9. The method according to claim 1, wherein the first fused image and the second fused image comprise additional intensity variations in areas of low texture compared to respective intensity image data, wherein the additional intensity variations are caused by illumination of the respective three-dimensional geometry data of the object by the directional lighting arrangement.

10. The method according to claim 1, wherein the directional lighting arrangement introduces one or more of specular reflections and shadowing effects arising from three-dimensional features of the object.

11. The method according to claim 1 further comprising, prior to the synthesising step, the steps of:
registering the first intensity image data and the first three-dimensional geometry data; and
registering the second intensity image data and the second three-dimensional geometry data.

12. The method according to claim 1, wherein the three-dimensional geometry data is dependent upon one of depth data and height data associated with the object.

13. The method according to claim 1, wherein the directional lighting arrangement comprises a plurality of virtual light sources.

14. The method according to claim 1, wherein the directional lighting arrangement is selected based on intensity gradient orientations in the intensity image data in at least one of the first object data and the second object data.

15. The method according to claim 13, wherein the directional lighting arrangement is selected based on the three-dimensional geometry data of at least one of the first object data and the second object data.

16. The method according to claim 1, wherein the alignment step comprises estimating a displacement field relating positions of pixels between the first fused image and the second fused image.

17. The method according to claim 1, wherein the aligning step comprises estimating the relative viewpoint of cameras capturing the first intensity image data and the second intensity image data.

18. An apparatus for combining object data captured from an object, the apparatus comprising:
a processor; and
a storage device for storing a processor executable software program for directing the processor to perform a method comprising the steps of:
receiving first object data and second object data, the first object data comprises first intensity image data and first three-dimensional geometry data of the object and the second object data comprises second intensity image data and second three-dimensional geometry data of the object;
synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data;
aligning the first fused image and the second fused image; and
combining the first object data and the second object data.

19. A tangible non-transitory computer readable storage medium storing a computer executable software program for directing a processor to perform a method for combining object data captured from an object, the method comprising the steps of:
receiving first object data and second object data, the first object data comprises first intensity image data and first three-dimensional geometry data of the object and the second object data comprises second intensity image data and second three-dimensional geometry data of the object;
synthesising a first fused image of the object and a second fused image of the object by fusing the respective intensity image data and the respective three-dimensional geometry data of the object illuminated by a directional lighting arrangement produced by a directional light source, the directional lighting arrangement produced by the directional light source being different to a lighting arrangement used to capture at least one of the first object data and the second object data;
aligning the first fused image and the second fused image; and
combining the first object data and the second object data.

20. A method of aligning object portions, the method comprising:
receiving intensity image data and three-dimensional geometry data for each of a first object portion and a second object portion;
determining a first shaded geometry image and a second geometry image by shading corresponding three-dimensional geometry data using at least one virtual light source and intensities derived from corresponding intensity image data; and
aligning the first shaded geometry image and the second shaded geometry image to align the first object portion and the second object portion.
